(19) United States
(12) Patent Application Publication
(10) Pub. No.: US 2025/0062578 A1
(43) Pub. Date: Feb. 20, 2025

(54) Electrical Plug-In Connection

(71) Applicant: Rosenberger Hochfrequenztechnik GmbH & Co. KG, Fridolfing (DE)

(72) Inventor: Ludwig Huber, Fridolfing (DE)

(21) Appl. No.: 18/802,444

(22) Filed: Aug. 13, 2024

(30) Foreign Application Priority Data
Aug. 14, 2023 (EP) 23 191 299.9

(51) Int. Cl. H01R 24/40; H01R 103/00

(52) U.S. Cl. CPC H01R 24/40; H01R 2103/00

(57) ABSTRACT

An electrical plug-in connection having an electrical plug-in connector that has an external conductor contact element and a corresponding electrical mating plug-in connector that has a mating external conductor contact element. A plug-side end region of the external conductor contact element defines an inner surface that is rotationally symmetrical with a longitudinal axis L₁ of the plug-in connector and the inner surface has an internal diameter which tapers in a direction opposite a plug-in direction S₁ of the plug-in connector; and a plug-side end region of the mating external conductor contact element defines an outer surface that is rotationally symmetrical with a longitudinal axis U of the corresponding electrical mating plug-in connector and the outer surface has an external diameter which tapers in a plug-in direction S₂ of the mating plug-in connector; and the inner surface and the outer surface make contact solely on a circular ling.

### FIELD OF THE INVENTION

The present invention relates to an electrical plug-in connection consisting of an electrical plug-in connector with an external conductor contact element and a corresponding electrical mating plug-in connector with a mating external conductor contact element in accordance with the preamble of Patent Claim 1.

### TECHNICAL BACKGROUND

Electrical plug-in connections consisting of an electrical plug-in connector and a corresponding mating plug-in connector are used for the disconnectable transmission of data signals and/or of electrical supply voltages. In order to prevent coupling and decoupling of electromagnetic radiation into and from the plug-in connection, plug-in connections are typically of shielded configuration. In the case of the transmission of high-frequency to maximum-frequency signals, in particular, particularly high requirements are made of the shielding. Here, the external conductor contact between the external conductor contact element of the plug-in connector and the mating external conductor contact element of the mating plug-in connector rarely takes place via radial contacting, since punctiform contact of the individual spring clips, required for this purpose, of an external conductor contact element does not make all-round external conductor contact possible. Rather, frontal contacting between the planar and plane-parallel contact surfaces of the external conductor contact element and the mating external conductor contact element is usually utilized in these areas of application.

While FIG. 1A shows a longitudinal sectional illustration of a plug-in operation between a plug-in connector and a mating plug-in connector, the longitudinal sectional illustration of FIG. 1B results in frontal contacting between the external conductor contact element and the mating external conductor contact element in the plugged-in state. The frontal contacting ideally makes full-area contact possible which is peripherally closed relative to the longitudinal axis of the plug-in connection and makes optimum shielding at the electrical and mechanical interface between the plug-in connector and the mating plug-in connector possible.

Reliable frontal contacting usually requires a comparatively high axial contact pressure. If, in contrast, the axial contact pressure is not sufficient, tilting can occur between the external conductor contact element and the corresponding mating external conductor contact element, as shown in FIG. 1C. The tilting is made possible, since a certain amount of play is required for the plug-in operation between the internal diameter of the external conductor contact element of the plug-in connector and the external diameter of the mating external conductor contact element of the mating plug-in connector.

The intended peripheral full-area contact therefore passes in the undesired, tilted state of the plugged-in plug-in connection into a single-side punctiform contact, with the result that the shielding and therefore the high-frequency transmission characteristic are impaired. Moreover, the single-side punctiform contact cannot be stable in character either, but can be variable over time and can therefore promote the generation of undesired passive intermodulation (PIM).

This is a state which needs to be improved.

### SUMMARY OF THE INVENTION

Against this background, the present invention is based on the object of specifying an electrical plug-in connection which makes reliable peripheral contact between the external conductor contact element and the mating external conductor contact element possible even in a tilted state between the plug-in connector and the mating plug-in connector.

According to the invention, this object is achieved by way of an electrical plug-in connection with the features of Patent Claim 1.

Accordingly, the following is provided:

An electrical plug-in connection consisting of
an electrical plug-in connector, and
a corresponding electrical mating plug-in connector,
the plug-in connector having an external conductor contact element, and
the mating plug-in connector having a mating external conductor contact element,
an inner surface being configured in a plug-side end region of the external conductor contact element, which inner surface is rotationally symmetrical with respect to a longitudinal axis of the plug-in connector and has an internal diameter which tapers in a direction which is opposed to a plug-in direction of the plug-in connector, and
an outer surface being configured in a plug-side end region of the mating external conductor contact element, which outer surface is rotationally symmetrical with respect to a longitudinal axis of the mating plug-in connector and has an external diameter which tapers in a plug-in direction of the mating plug-in connector,
the inner surface and the outer surface making contact solely on a circular line.

The finding/concept forming the basis of the present invention consists in configuring an inner surface in the contacting region of the external conductor contact element, the internal diameter of which inner surface tapers in the direction opposed to the plug-in direction of the plug-in connector, and configuring an outer surface in the contacting region of the mating external conductor contact element, the external diameter of which outer surface tapers in the plug-in direction of the mating plug-in connector. In this way, a contact force with an axial force component and a radial or lateral force component relative to the longitudinal axis of the plug-in connector can be realized on the inner surface of the external conductor contact element, and a contact force with an axial force component and a radial or lateral force component relative to the longitudinal axis of the mating plug-in connector can be realized on the outer surface of the mating external conductor contact element.

The invention is suitable, in particular (but not exclusively), for use with a plug-in connection, in the case of which there is a mechanical play, for example as a result of manufacturing tolerances, which play permits tilting of the plug-in partners in the plugged-in state.

The rotationally symmetrical inner surface is preferably a completely contiguous surface and is as a rule not to be understood within the context of the invention as a combination of a plurality of individual surfaces. The same preferably applies to the outer surface.

The plug-in connector particularly preferably has solely the (in particular, precisely one contiguous) inner surface, and the mating plug-in connector has solely the (in particular, precisely one contiguous) outer surface for the electrical and mechanical external conductor contacting.

No contact spring clips are preferably involved in the electrical and mechanical external conductor contacting.

If, moreover, a linear contact, in particular contact solely on a circular line, is realized instead of a full-area contact between the outer surface and the inner surface, a circular line on the inner surface can be brought into contact for every tilting angle between the longitudinal axis of the plug-in connector and the longitudinal axis of the mating plug-in connector in each case with a circular line, corresponding to the tilting angle, on the outer surface. Therefore, a different circular line on the outer surface is in each case in a circular line-shaped contact with the inner surface in a manner which is dependent on the magnitude of the tilting angle.

Contacting on a circular line requires an inner surface, of rotationally symmetrical configuration with respect to the longitudinal axis of the plug-in connector, of the external conductor contact element, and an outer surface, of rotationally symmetrical configuration with respect to the longitudinal axis of the mating plug-in connector, of the mating external conductor contact element. The circular line of the contact is situated on the inner surface of the external conductor contact element if the center point of the circular line comes to lie on the longitudinal axis of the plug-in connector.

If there is no tilting between the longitudinal axis of the plug-in connector and the mating plug-in connector, that is to say the longitudinal axes of the plug-in connector and the mating plug-in connector are aligned with one another, the circular line of the contact is situated both on the inner surface of the external conductor contact element and on the outer surface of the mating external conductor contact element if the center point of the circular line comes to lie both on the longitudinal axis of the plug-in connector and on the longitudinal axis of the mating plug-in connector.

It can be provided, in particular, that the inner surface and the outer surface make contact on a circular line in at least one possible plug-in state of the plug-in connection, preferably in a plurality of possible plug-in states, in particular even in the case of a coaxial orientation of the longitudinal axes of the plug-in connector and the mating plug-in connector. The inner surface and the outer surface particularly preferably make contact on a circular line in all possible plug-in states.

The orientation of the contact plane which is defined by the contacting circular line of the contact plane is tilted by a tilting angle with respect to the longitudinal axis of the mating plug-in connector in the case of tilting between the longitudinal axis of the plug-in connector and the longitudinal axis of the mating plug-in connector. The orientation of the contact plane results from the orientation of a surface vector of the contact plane through the center point of the contacting circular line on the outer surface.

Contacting occurs between the inner surface of the external conductor contact element and the outer surface of the mating external conductor contact element if the contacting region of the external conductor contact element and of the mating external conductor contact element are situated in each case in the plug-side end region of the plug-in connector and the mating plug-in connector, respectively, and the mating external conductor contact element on the plug-side end region of the mating plug-in connector is inserted into the external conductor contact element of the plug-in connector.

The all-round contacting between the external conductor contact element and the mating external conductor contact element advantageously makes all-round shielding or all-round shielding transmission and therefore a high frequency transmission characteristic which is optimized with regard to the shielding in the plug-in connection possible for tilting of different magnitude between the plug-in connector and the corresponding mating plug-in connector and also for the non-tilted case.

Moreover, the linear contacting on the circular line makes a higher contact pressure possible in comparison with full-area contacting. In this way, undesired deviations in the contact areas between the contact partners can already be compensated for with low contact forces, and an all-round electrical contact can therefore be achieved more effectively between the contact partners.

Finally, in comparison with a full-area contact, the linear contact makes scrubbing between the contact surfaces possible in the case of a tilting movement, in particular in the case of a multiply repeated tilting movement (in the case of a plurality of plug-in cycles), between the plug-in connector and the mating plug-in connector. An oxide layer which is formed on the contact surface over time and increases the contact resistance in an undesired manner is advantageously eliminated by way of the scrubbing movement of the linear contact and therefore keeps the contact resistance low.

If an axial offset between the longitudinal axis of the plug-in connector and the longitudinal axis of the mating plug-in connector occurs during the plug-in operation, the tapering of the internal diameter of the inner surface of the external conductor contact element which is configured in the plug-in direction of the mating plug-in connector makes centering and therefore an axial orientation of the mating plug-in connector in the plug-in connector possible.

The external diameter of the inner surface of the external conductor contact element and the internal diameter of the outer surface of the mating external conductor contact element can in each case taper in a manner which is linear, curved or single-stepped or multiple-stepped. In the case of curved tapering, a curvature with a constant curvature radius or with a variable curvature radius is conceivable. The curvature can be of convex or concave shape. In the case of linear tapering of the external or internal diameter, there is a conically shaped outer surface or a conically shaped inner surface. In the case of convexly or concavely shaped tapering of the external or internal diameter, there is a convexly or concavely curved outer surface or a convexly or concavely curved inner surface. In the case of convexly or concavely curved tapering of the internal diameter of the inner surface or of the external diameter of the outer surface with a constant curvature radius, there is a convexly spherical or concavely spherical curvature of the outer surface or of the inner surface. In all remaining cases of a curvature, there is an aspherical curvature. The transition between a convex curvature and a concave curvature, that is to say an S-shaped curvature, is also conceivable as a special case of an aspherical curvature.

The outer surface, the external diameter of which tapers, and the inner surface, the internal diameter of which tapers, can extend over a greater axial portion of the mating external conductor contact element and the external conductor contact element, respectively. As an alternative, the outer surface, the external diameter of which tapers, and the inner surface, the internal diameter of which tapers, can also in each case be configured only in the axial portion of a rounded edge or a beveled edge.

If the external diameter of the outer surface or the internal diameter of the inner surface tapers in each case in a linear, convexly curved or concavely curved manner, the tapering takes place continuously along the entire axial extent of the outer surface or of the inner surface. It is ensured in this way that, for each technically appropriate tilting angle between the longitudinal axis of the plug-in connector and the longitudinal axis of the mating plug-in connector, a circular line on the outer surface makes contact over the full periphery in each case with a circular line on the inner surface.

It can be provided in one development of the invention that the internal diameter of the inner surface and the external diameter of the outer surface taper with a different slope or different curvature radii.

The case is also conceivable where the outer surface or the inner surface each have a plurality of axial portions, the internal diameters of which or the external diameters of which in each case taper in a linear manner with a different slope or in each case taper in a curved manner with different curvature radii. A plurality of axial portions of the outer surface or of the inner surface can also be realized which form a combination of conical and curved tapering of the internal or external diameter. In these cases, a peripheral edge can be formed in each case at the transition between the individual axial portions of the outer surface or the inner surface.

It can be provided in one particularly advantageous development of the invention that the internal diameter of the inner surface tapers in a linear or stepped (single-stepped or multiple-stepped) manner, and the external diameter of the outer surface tapers in a curved manner, or vice versa. In particular, a combination of non-curved or non-curvy tapering with curved or curvy tapering has proved to be particularly advantageous.

As has already been mentioned above, the contacting circular line between the inner surface of the external conductor contact element and the outer surface of the mating external conductor contact element changes its position on the outer surface of the mating external conductor contact element if the tilting angle between the longitudinal axis of the plug-in connector and the longitudinal axis of the mating plug-in connector changes. This change in the position of the contacting circular line on the outer surface of the mating external conductor contact element occurs only if the external diameter of the outer surface tapers in a linear or curved manner. In the case of stepped tapering of the external diameter of the outer surface, a change in the position of the contacting circular line on the outer surface of the mating external conductor contact element is not possible. In this case, the contacting circular line on the outer surface is positioned for different tilting angles on the outer edge of the external diameter, tapering in a stepped manner, of the outer surface.

The contacting of the inner surface of the external conductor contact element and the outer surface of the mating external conductor contact element on a circular line is a linear contact. A linear contact on a circular line includes, here and in the following text, not only the linear contact which occurs in the idealized case, but rather also the flattening, occurring as a result of the residual elasticity of the external conductor contact element and the mating external conductor contact element in the case of a defined contact pressure, of the circular line-shaped contact between the external conductor contact element and the mating external conductor contact element (what is known as surface pressure or Hertzian stress).

The external conductor contact element and the mating external conductor contact element are in each case sleeve-shaped contact elements made from a material with satisfactory mechanical and electrical properties, preferably consisting of brass, bronze, steel or stainless steel. In order to minimize the contact resistance in the contact region, the external conductor contact element and the mating external conductor contact element can be coated with a coating material with a satisfactory electrical conductivity, preferably with gold, silver or nickel, in particular in the contacting region. As an alternative, however, an uncoated contact surface is also conceivable.

Since the external conductor contact element and the mating external conductor contact element each have a contacting region which is shaped in a rotationally symmetrical manner, that is to say a rotationally symmetrical inner surface and a rotationally symmetrical outer surface, the edges of the outer surface and the edges of the inner surface, in particular the inner edge of the outer surface and the inner surface, are preferably also of rotationally symmetrical configuration. To this extent, the through bore of the external conductor contact element and the mating external conductor contact element for receiving the internal conductor contact element and the mating internal conductor contact element, respectively, preferably each have a round cross-sectional profile. Therefore, a single internal conductor contact element for configuring a coaxial plug-in connector is preferably received in the round through bore of the external conductor contact element, and a single mating internal conductor contact element for configuring a coaxial mating plug-in connector is preferably received in the round through bore of the mating external conductor contact element. As an alternative, however, a plurality of internal conductor contact elements and a plurality of mating internal conductor contact elements, for example two or four internal conductor contact elements and two or four mating internal conductor contact elements, are also conceivable.

The plug-in connector and the mating plug-in connector are each preferably a cable plug-in connector. It is also possible, however, that the plug-in connector or, as an alternative, the mating plug-in connector is configured in each case as a printed circuit board plug-in connector, a housing plug-in connector, a flush-type plug-in connector or an adapter plug-in connector. The plug-in connector and the mating plug-in connector are preferably configured in each case as a straight plug-in connector. An angled variant for the plug-in connector and the mating plug-in connector is also conceivable in each case. In this variant, the feature mentioned up to now and in the following text of a longitudinal axis of the plug-in connector and a longitudinal axis of the mating plug-in connector relates to the longitudinal axis of the plug-in connector and the mating plug-in connector in the plug-side end region of the plug-in connector and the mating plug-in connector.

Advantageous refinements and developments result from the further subclaims and from the description with reference to the figures of the drawing.

It goes without saying that the features which are mentioned above and are still to be explained in the following text can be used not only in the respectively specified combination, but rather also in other combinations or on their own, without departing from the scope of the present invention.

In the case of an external diameter and internal diameter which taper in a linear or curved manner, the inner surface of the external conductor contact element and the outer surface of the mating external conductor contact element can preferably have a slope relative to the longitudinal axis of the plug-in connector and relative to the longitudinal axis of the mating plug-in connector, respectively, in a range between 35° and 75° and preferably in a range between 55° and 65°, and can particularly preferably be 60°,

If the slopes of the inner surface and the outer surface are each lower than the stated parameter ranges, an inaccuracy in the axial position of the mating plug-in connector can occur in the case of manufacturing tolerances. If the slopes of the inner surface and the outer surface are each of greater dimensions than the stated parameter ranges, a static friction which occurs between the contact surfaces can prevent centering between the plug-in connector and the mating plug-in connector.

In one preferred embodiment of the invention, the circular line-shaped contacting between the inner surface of the external conductor contact element and the outer surface of the mating external conductor contact element can occur for respectively different tilting angles between the plug-in connector and the mating plug-in connector if the circular line is positioned on a peripheral outer edge of the outer surface or the inner surface or on a convex curvature of the outer surface or the inner surface.

Here and in the following text, a peripheral outer edge is understood to mean, in a distinction from a peripheral inner edge, a peripheral edge which rises on the inner surface of the external conductor contact element in the direction of the outer surface, arranged opposite, of the mating external conductor contact element or on the outer surface of the mating external conductor contact element in the direction of the inner surface, arranged opposite, of the external conductor contact element. The peripheral outer edge is the boundary between two falling part surfaces of the inner and the outer surface. The angle between the falling part surfaces of the outer edge can lie between an acute and an obtuse angle. In the first case, there is an outer edge which is configured as a burr. In the second case, there is an outer edge between two flatly rising part surfaces of the inner and the outer surface. If there is an angle between the falling part surfaces of the inner and the outer surface of 90°, there is stepped tapering of the internal diameter of the inner surface or the external diameter of the outer surface.

A peripheral convex curvature of the inner or the outer surface which is also called a peripheral positive curvature is an outwardly directed curvature of the outer surface of the inner or the outer surface. This has a convex curvature in the direction of the tapering internal diameter of the inner surface or of the external diameter of the outer surface. If an outer edge or a convex curvature in the direction of the inner surface is configured in each case solely on the outer surface or an outer edge or a convex curvature in the direction of the outer surface is configured in each case solely on the inner surface, the tapering of the diameter of the respectively opposite surface to be contacted, that is to say the tapering of the internal diameter of the inner surface and the tapering of the external diameter of the outer surface, can in each case be configured in a manner which is conical, single-stepped or multiple-stepped, convexly curved or concavely curved.

In a further preferred embodiment of the invention, the inner surface can be configured in each case spaced apart axially from a plug-side end of the external conductor contact element, or the outer surface can be configured in each case spaced apart axially from a plug-side end of the mating external conductor contact element.

If that inner surface of the plug-in connector, in which the internal diameter tapers in a direction which is opposed to the plug-in direction of the plug-in connector, can be arranged spaced apart axially from the plug-side end of the external conductor contact element, the external conductor contact element has an introduction region for introducing the mating external conductor contact element. In this way, the external conductor contact element can be aligned with respect to the mating external conductor contact element in the plug-in operation of the plug-in connector to the mating plug-in connector in a first plug-in process step before an alignment of the internal conductor contact element with respect to the mating internal conductor contact element takes place. For improved alignment of the external conductor contact element with respect to the mating external conductor contact element, a capturing funnel functionality can be configured in the introduction region. To this end, either the plug-side end of the introduction region can have a bevel or the entire axial portion of the introduction region can be shaped conically.

As an alternative, that outer surface of the mating plug-in connector, in which the external diameter tapers in the plug-in direction of the mating plug-in connector, can be arranged spaced apart axially from a plug-side end of the mating external conductor contact element, in order to align the external conductor contact element with respect to the mating external conductor contact element before the alignment of the internal conductor contact element with respect to the mating internal conductor contact element in the plug-in operation of the plug-in connector to the mating plug-in connector. Here, the plug-side end of the mating external conductor contact element is centered on the inner surface of the external conductor contact element, the internal diameter of which tapers in a direction which is opposed to the plug-in direction of the plug-in connector. In this case, the external conductor contact element cannot have any introduction region which is positioned upstream of the region of the outer surface on the plug-in side. In order to improve the centering of the mating external conductor contact element with respect to the external conductor contact element, a bevel can be configured at the plug-side end of the mating external conductor contact element.

In a further preferred embodiment of the invention, the plug-in connector and/or the mating plug-in connector can each have an axially acting clamping means, in order for the inner surface of the external conductor contact element to make contact with the outer surface of the mating external conductor contact element with a sufficient contact press sure. An axially acting clamping spring which is clamped in between the plug-in connector housing and the external conductor contact element in a prestressed manner can preferably be used here. The spring force of the clamping spring acts on the external conductor contact element and realizes a contact force in the plug-in direction for the external conductor contact element. As an alternative or in addition to the clamping spring of the plug-in connector, a clamping spring can also be provided which is clamped in between the mating plug-in connector housing and the mating external conductor contact element in a prestressed manner and generates a contact force which acts in the plug-in direction for the mating external conductor contact element.

An alternative technical solution for generating a contact force can also be a joint bolted connection, in particular by means of a union nut which is configured with an internal thread, between the plug-in connector and the mating plug-in connector. Finally, magnets or latching means can also be provided as clamping means.

In order to transmit a high-frequency or maximum-frequency signal, the plug-in connector can additionally have an internal conductor contact element which can be arranged at least in sections within the external conductor contact element, and the mating plug-in connector can additionally have a mating internal conductor contact element which can be arranged at least in sections within the mating external conductor contact element. In the plugged-in state of the plug-in connection, the internal conductor contact element and the mating internal conductor contact element can preferably make contact within an axial portion of the mating external conductor contact element. If the internal conductor contact element can preferably be arranged solely within a portion of the external conductor contact element, both the internal conductor contact element can be arranged protected within the external conductor contact element, and the mating internal conductor contact element can be arranged protected within the mating external conductor contact element.

Moreover, an arrangement of this type between the internal conductor contact element, the mating internal conductor contact element, the external conductor contact element and the mating external conductor contact element can bring about, in the case of tilting between the plug-in connector and the mating plug-in connector, in particular in the case of a relatively great tilting angle, bending of the internal conductor contact element and/or the mating internal conductor contact element and, to a greater extent, permanent destruction of the internal conductor contact element and/or the mating internal conductor contact element, or a release of the contact between the internal conductor contact element and the mating internal conductor contact element.

In one particularly preferred embodiment, the contact between the internal conductor contact element and the mating internal conductor contact element can be arranged in an axial portion, adjacent with respect to the plug-side end of the mating external conductor contact element, of the mating external conductor contact element, that is to say in the axial portion of the outer surface of the mating external conductor contact element. In one ideal embodiment, the contact between the internal conductor contact element and the mating internal conductor contact element can be arranged in a rotational or a tilting center of the outer surface of the mating external conductor contact element.

In the last-but-one mentioned case and very particularly in the last-mentioned case, the mating internal conductor contact element rotates relative to the internal conductor contact element in the case of tilting between the plug-in connector and the mating plug-in connector adjacently with respect to or exactly in their contact region, with the result that no damage or at least only very small damage occurs on the internal conductor contact element and/or on the mating internal conductor contact element.

The internal conductor contact element and the mating internal conductor contact element can make contact with one another in the usual way in a radial contact, preferably in accordance with the socket/pin principle.

In a further preferred embodiment of the invention, the contacting between the internal conductor contact element and the mating internal conductor contact element earn be implemented in accordance with the contacting principle of the external conductor contact element with the mating external conductor contact element.

To this end, in a first embodiment of the contacting principle, an inner sheath surface with an internal diameter which tapers in a direction opposed to a plug-in direction of the plug-in connector can be configured in a plug-side end region of the internal conductor contact element, and an outer sheath surface with an external diameter which tapers in a plug-in direction of the mating plug-in connector can be configured in a plug-side end region of the mating internal conductor contact element.

To this end, in a second embodiment of the contacting principle, an outer sheath surface with an external diameter which tapers in a plug-in direction of the plug-in connector can be configured in a plug-side end region of the internal conductor contact element, and an inner sheath surface with an internal diameter which tapers in a direction opposed to a plug-in direction of the mating plug-in connector can be configured in a plug-side end region of the mating internal conductor contact element.

In both embodiments of the contacting principle, the inner sheath surface can make contact with the outer sheath surface in each case solely on a circular line.

The individual technical features explained above in each case with respect to the inner surface of the external conductor contact element and with respect to the outer surface of the internal conductor contact element apply equivalently to the technical embodiment of the inner sheath surface or the outer sheath surface of the internal conductor contact element and the outer sheath surface or the inner sheath surface of the corresponding mating internal conductor contact element.

In order to realize a contact pressure between the internal conductor contact element and the mating internal conductor contact element, the internal conductor contact element and/or the mating internal conductor contact element can preferably in each case be mounted in a sprung manner. In one particularly preferred embodiment, to this end, the internal conductor contact element and/or the mating internal conductor contact element can each have a compression spring which can be arranged between two axially spaced-apart part bodies of the internal conductor contact element and/or the mating internal conductor contact element.

The above refinements and developments can be combined as desired with one another, if appropriate. Further possible refinements, developments and implementations of the invention also comprise combinations which are not mentioned explicitly of features of the invention which are described above or in the following text with regard to the exemplary embodiments.

Here, in particular, a person skilled in the art will also add individual aspects as improvements or supplements to the respective basic form of the present invention.

### CONTENTS OF THE DRAWING

The present invention will be explained in greater detail in the following text on the basis of the exemplary embodiments specified in the diagrammatic figures of the drawing, in which:

FIGS. 1A, 1B, 1C show longitudinal sectional illustrations of a plug-in connection according to the prior art in the non-plugged-in state, in the plugged-in and non-tilted state, and in the plugged-in and tilted state,

FIGS. 2A,2B,2C show longitudinal sectional illustrations of a first embodiment of a plug-in connection according to the invention in the non-plugged-in state, in the plugged-in and non-tilted state, and in the plugged-in and tilted state,

FIG. 2D shows an illustration of a detail of a first embodiment of a plug-in connection according to the invention in the plugged-in and non-tilted state,

FIG. 2E shows a plan view of a mating external conductor contact element in the plugged-in and tilted state,

FIG. 3 shows longitudinal sectional illustrations of a second embodiment of a plug-in connection according to the invention in the plugged-in and non-tilted state,

FIGS. 4A,4B,4C show longitudinal sectional illustrations of an enhancement of the plug-in connection according to the invention in the non-plugged-in state, in the plugged-in and non-tilted state, and in the plugged-in and tilted state,

FIGS. 5A, 5B show longitudinal sectional illustrations of two design variants for applying a contact force for a plug-in connection according to the invention, and

FIGS. 6A-6M show longitudinal sectional illustrations for different geometries of a plug-in connection according to the invention.

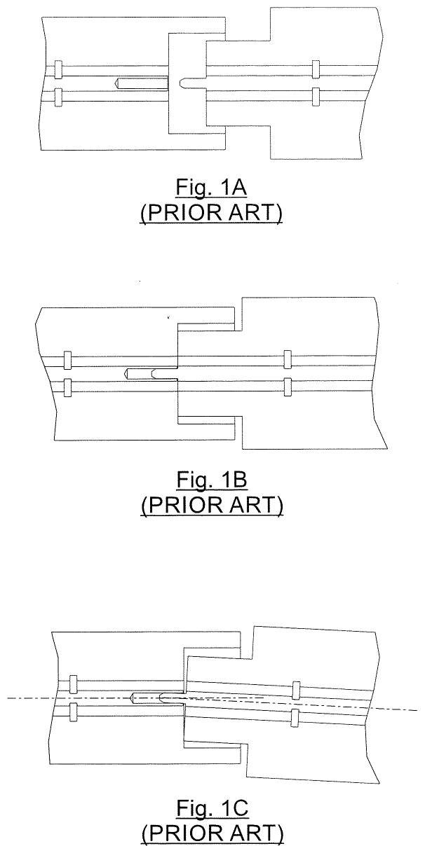

The appended figures of the drawing are intended to impart further understanding of the embodiments of the invention. They illustrate embodiments and serve, in conjunction with the description, to explain principles and concepts of the invention. Other embodiments and many of the stated advantages result with regard to the drawings. The elements of the drawings are not necessarily shown true to scale with respect to one another.

In the figures of the drawing, identical, functionally identical and identically acting elements, features and components are provided in each case with the same reference signs, unless stated otherwise.

In the following text, the figures are described in a coherent and universal manner.

### DESCRIPTION OF EXEMPLARY EMBODIMENTS

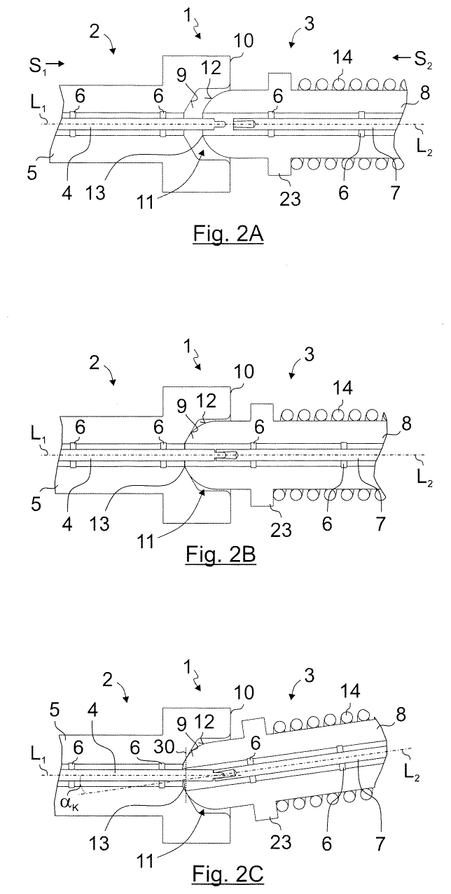

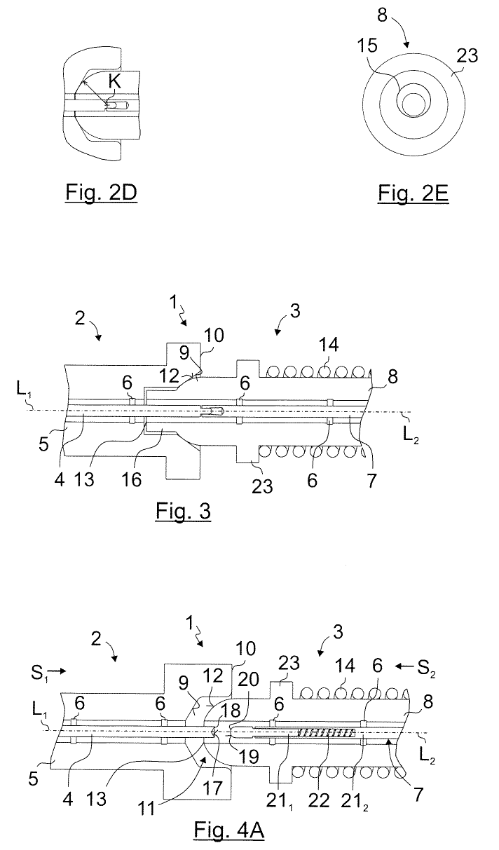

FIGS. 2A to 2E show a first embodiment of a plug-in connection 1 according to the invention consisting of a plug-in connector 2 and a corresponding mating plug-in connector 3. The plug-in connector 2 has an internal conductor contact element 4 and an external conductor contact element 5 which encases the internal conductor contact element 4. The internal conductor contact element 4 is spaced apart via a plurality of dielectric spacer elements 6 from the external conductor contact element 5 and is therefore electrically insulated from the latter. In an equivalent manner, the mating plug-in connector 3 has a mating internal conductor contact element 7 and a mating external conductor contact element 8 which encases the mating internal conductor contact element 7. The mating internal conductor contact element 7 is likewise spaced apart via a plurality of dielectric spacer elements 6 from the mating external conductor contact element 8 and is therefore electrically insulated from the latter.

The external conductor contact element 5 has an inner surface 9 of conical configuration, the internal diameter of which tapers in a direction opposed to the plug-in direction S₁ of the plug-in connector 2. The tapering inner surface 9 is arranged spaced apart axially with respect to the plug-side end 10 of the external conductor contact element 5 in the direction which is opposed to the plug-in direction S₁, in order to form an introduction region 11 for the mating external conductor contact element 8.

The mating external conductor contact element 8 has a convexly curved outer surface 12, that is to say a spherically shaped outer surface 12, the external diameter of which tapers in the plug-in direction S₂ of the mating plug-in connector 3. The tapering outer surface 12 of the mating external conductor contact element 8 directly adjoins the plug-side end 13 of the mating external conductor contact element 8.

The mating external conductor contact element 8 is mounted in a sprung manner in the plug-in direction S₂ of the mating plug-in connector 3 via a spring 14, preferably via a clamping spring 14 which encases the mating external conductor contact element 8 spirally. The clamping spring 14 is preferably clamped in between a flange 23, configured on the external conductor contact element 8, and a plug-in connector housing, not shown in FIGS. 2A to 2E, of the mating plug-in connector 3.

In the plugged-in state of the plug-in connection 1 according to FIGS. 2B to 2E, the spherically configured outer surface 12 of the mating external conductor contact element 3 makes contact with the conically configured inner surface 9 of the external conductor contact element 2. Here, the external conductor contact element 5 makes contact with the mating external conductor contact element 8 solely on a circular line 15 (in this regard, see FIG. 2E) both for the non-tilted (coaxial) state between the longitudinal axis L₁ of the plug-in connector 2 and the longitudinal axis L₂ of the mating plug-in connector 3 according to FIG. 2B and for the tilted state according to FIG. 2C. In this way, a respectively peripheral contact with respect to the longitudinal axis L₁ of the plug-in connector 2 and the longitudinal axis L₂ of the mating plug-in connector 3 is established between the external conductor contact element 2 and the mating external conductor contact element 3, which contact prevents radiation of a high-frequency or maximum-frequency radiation into or out of the plug-in connection 1.

A longitudinal axis which runs through the center point of the contacting circular line 15 on the outer surface 12 of the mating plug-in connector 3 and is oriented orthogonally with respect to a contact plane 30 (in this regard, see FIG. 2E), which is defined by the contacting circular line 15 on the outer surface 12 of the mating plug-in connector 3, is tilted with respect to the longitudinal axis L₂ of the mating plug-in connector 3 by the tilting angle α_{K} between the longitudinal axis L₁ of the plug-in connector 2 and the longitudinal axis L₂ of the mating plug-in connector 3. The center point of the circular line of the contact on the outer surface 12 of the mating plug-in connector 3 is not situated on the longitudinal axis L₂ of the mating plug-in connector 3, but rather is arranged spaced apart axially with respect to the longitudinal axis L₂ of the mating plug-in connector 3 in a manner which is dependent on the tilting angle α_{K}, as can be seen from FIG. 2E.

The contacting between the internal conductor contact element 4 and the mating internal conductor contact element 7 takes place radially in accordance with a customary pin/socket principle, as shown in FIGS. 2A to 2D. As shown in FIG. 2D, the contacting between the internal conductor contact element 4 and the mating internal conductor contact element 7 is ideally arranged in the curvature or tilting center point F of the spherically curved outer surface 12 of the mating external conductor contact element 8, in order to prevent bending or damage of the internal conductor contact element 4 and the mating external conductor contact element 7.

A second embodiment of a plug-in connection 1 according to the invention is apparent from FIG. 3. Here, in comparison with the first embodiment, the outer surface 12 of the mating external conductor contact element 8 is arranged spaced apart axially from the plug-side end 13 of the mating external conductor contact element 8. To this end, the mating external conductor contact element 8 has, between the plug-side end 13 and the tapering outer surface 12 of the mating external conductor contact element 8, an axial portion 16 which is shaped in a hollow-cylindrical manner and additionally facilitates an insertion of the mating external conductor contact element 8 into the introduction region 11 of the external conductor contact element 5.

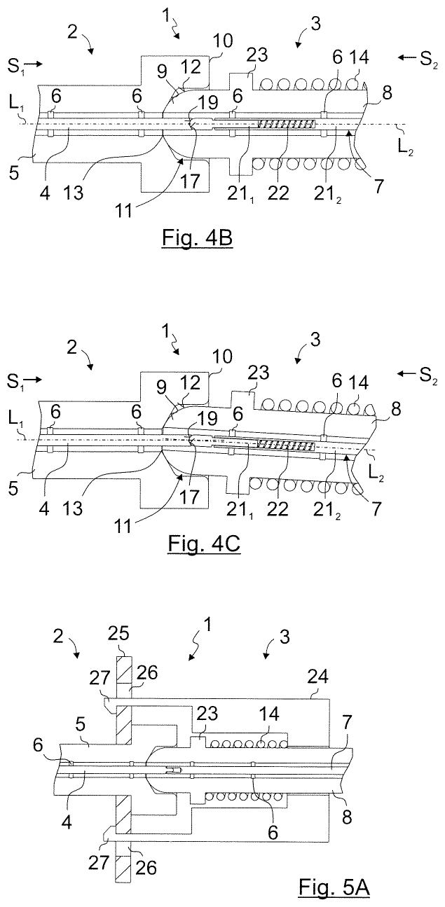

FIGS. 4A to 4C illustrate a preferred enhancement of the plug-in connection 1 according to the invention, in which, in addition to the contacting of the external conductor contact element 5 and the mating external conductor contact element 8 on a circular line 15, circular line-shaped contacting of the internal conductor contact element 4 and the mating internal conductor contact element 7 is realized.

To this end, the internal conductor contact element 4 has a conical inner sheath surface 17, the internal diameter of which tapers in a direction which is opposed to the plug-in direction S₁ of the plug-in connector 2. The tapering inner sheath surface 17 preferably extends directly adjacently to the plug-side end 18 of the internal conductor contact element 4. Moreover, the mating internal conductor contact element 7 has an outer sheath surface 19, the external diameter of which tapers in the plug-in direction S₂ of the mating plug-in connector 3. The tapering outer sheath surface 19 extends in an analogous manner from the plug-side end 20 of the mating internal conductor contact element 7.

In order to realize a sufficient contact force between the internal conductor contact element 4 and the mating external conductor contact element 7, the mating internal conductor contact element 7 has two part bodies 21₁ and 21₂ which are spaced apart axially and are connected to one another via a spring 22, preferably a compression spring 22. In this way, that part body 21₁ of the mating internal conductor contact element 7 which is arranged at the plug-side end 20 of the mating internal conductor contact element 7 and has the tapering outer sheath surface 19 is mounted in a sprung manner in the plug-in direction S₂ of the mating plug-in connector 3. The compression spring 22 is prestressed in the plugged-in state of the plug-in connection 1 according to FIGS. 4B and 4C, with the result that the spring force of the compression spring 22 presses the part body 21₁ of the mating internal conductor contact element 7 against the internal conductor contact element 4 with a certain contact pressure. The further part body 21₂ of the mating internal conductor contact element 7 is fixed, for example, to the dielectric spacer elements 6.

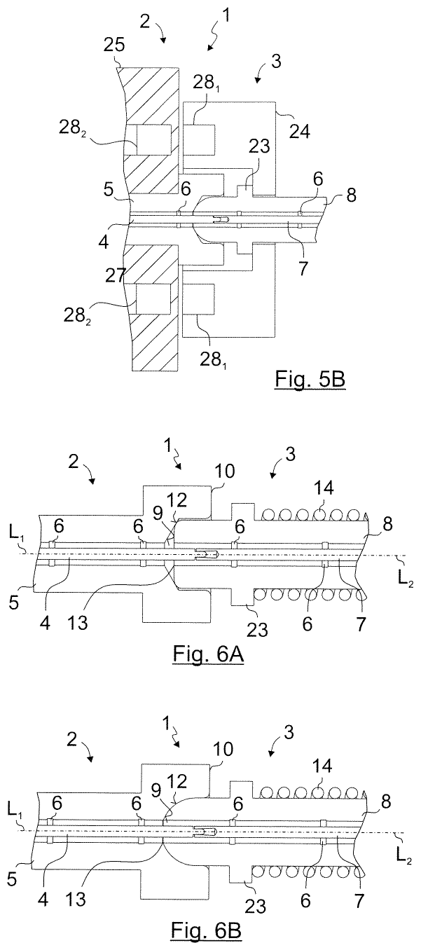

An overall illustration of a plug-in connection 1 is apparent from FIG. 5A, in which the contact pressure for the external conductor contacting is realized by a clamping spring 14. To this end, the clamping spring 14 is clamped in between a flange 23, which is configured on the outer sheath side of the mating external conductor contact element 7, and a plug-in connector housing 24 of the mating plug-in connector 3. The plug-in connector housing 24 of the mating plug-in connector 3 is connected to the plug-in connector housing 25 of the plug-in connector 2 via, for example, a latching connection. To this end, the plug-in connector housing 25 of the plug-in connector 2 has at least one latching means 26 which, to this end, is configured in each case, for example, as a latching leadthrough, into which a corresponding mating latching means 27 of the plug-in connector housing 24 of the mating plug-in connector 3 is inserted and latched. As a result of the latching action between the latching means 26 and the mating latching means 27, the clamping spring 14 is compressed, with the result that its spring force presses the external conductor contact element 8 against the mating external conductor contact element 5 with a contact force which corresponds to the spring force.

Instead of a latching connection between the plug-in connector housing 24 of the mating plug-in connector 3 and the plug-in connector housing 25 of the plug-in connector 2, a bayonet connection or a bolted connection is also conceivable as an alternative.

As an alternative to the generation of a contact force by means of a prestressed clamping spring 14, clamping between the external conductor contact element 5 and the associated mating external conductor contact element 8 by means of a magnetic connection according to FIG. 5B is also possible.

To this end, at least one magnetic connection, preferably a plurality of magnetic connections, is/are configured between the plug-in connector housing 25 of the plug-in connector 2 and the plug-in connector housing 24 of the mating plug-in connector 3. Each magnetic connection consists in each case of a first magnet 28₁ and a second magnet 28₂ which attract each other on account of their different magnetic polarity. The magnet 28₁ is preferably arranged on an end surface or in a region, adjacent to the end surface, of the plug-in connector housing 24 of the mating plug-in connector 3, while the magnet 28₂ is preferably arranged on an opposite end surface or in a region, adjacent to the opposite end surface, of the plug-in connector housing 25 of the plug-in connector 2.

The mating external conductor contact element 8 is driven via its flange 23, configured on its outer sheath side, by the plug-in connector housing 24 of the mating plug-in connector 3 axially in the plug-in direction S₂ of the mating plug-in connector 3 and is pressed against the external conductor contact element 5 with a certain contact pressure when the plug-in connector housing 24 of the mating plug-in connector 3 is tightened and therefore fixed via the at least one magnetic connection on the plug-in connector housing 25 of the plug-in connector 2.

As an alternative to the clamping action, the contact force between the external conductor contact element 5 and the corresponding mating external conductor contact element 8 can be realized by way of a spring force of a clamping spring 14 or by way of the magnetic attraction force between two magnets, and also by way of the clamping force of a bolted connection, a bayonet connection or a latching connection between the plug-in connector housings 24 and 25 of the mating plug-in connector 3 and the plug-in connector 2.

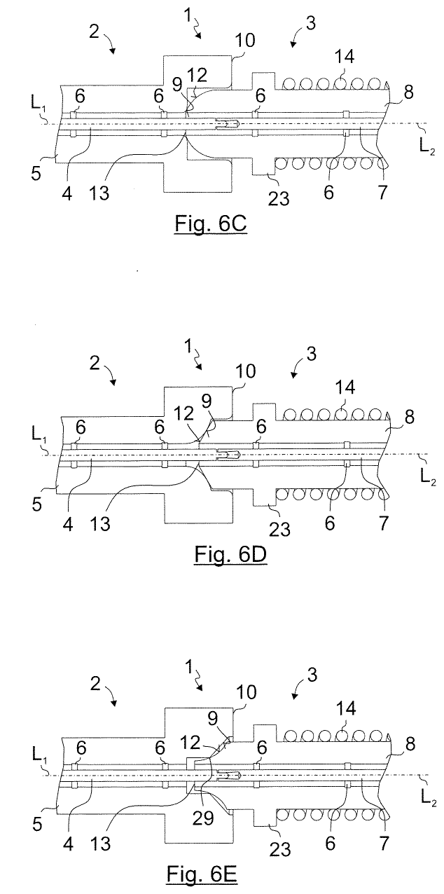

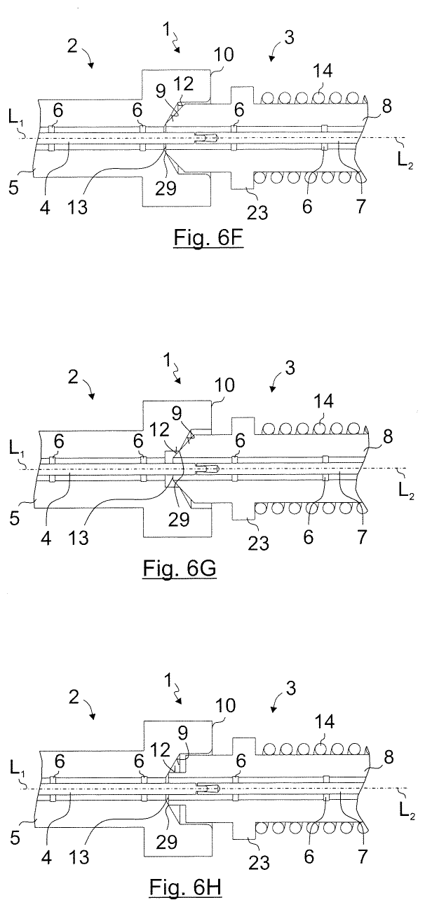

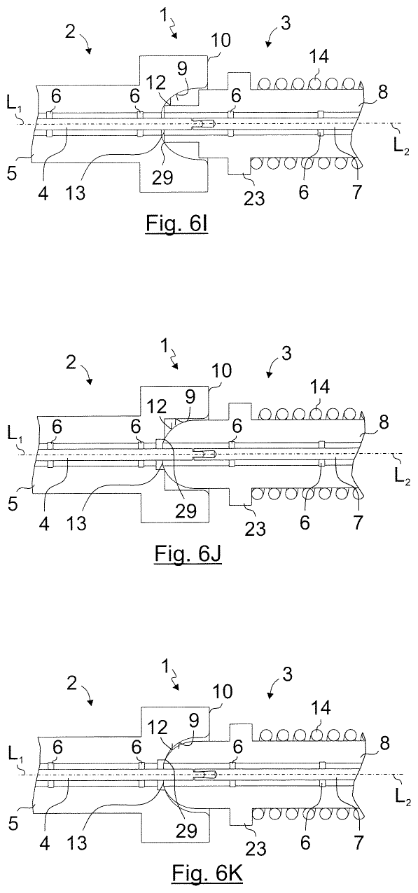

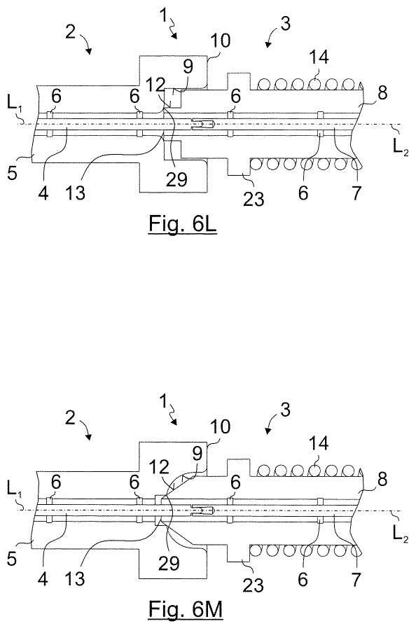

As an alternative to the previously described circular line-shaped contacting between a conically shaped inner surface 9 of the external conductor contact element 5 and a spherically curved outer surface 12 of the mating external conductor contact element 8, other geometry combinations for a circular line-shaped contacting are also conceivable, as shown in the following FIGS. 6A to 6M:

Circular line-shaped contacting between the external conductor contact element 5 and the corresponding mating external conductor contact element 8 results from FIG. 6A via a conically shaped inner surface 9 of the external conductor contact element 5 and a rounded edge between the plug-side end surface and the sheath surface of the mating external conductor contact element 8.

FIG. 6B shows circular line-shaped contacting between a concavely curved inner surface 9 of the external conductor contact element 5 and a convexly curved outer surface 12 of the mating external conductor contact element 8.

FIG. 6C shows circular line-shaped contacting between a convexly curved inner surface 9 of the external conductor contact element 5 and a likewise convexly curved outer surface 12 of the mating external conductor contact element 8.

FIG. 6D illustrates circular line-shaped contacting between a convexly curved inner surface 9 of the external conductor contact element 5 and a conically shaped outer surface 12 of the mating external conductor contact element 8.

FIG. 6E shows circular line-shaped contacting between an outer edge 29 on the inner surface 9 of the external conductor contact element 5 and a concavely curved outer surface 12 of the mating external conductor contact element 8.

In FIG. 6F, the inner surface 9 of the external conductor contact element 5 and the outer surface 12 of the mating external conductor contact element 8 are each conically shaped. The circular line-shaped contact between the inner surface 9 and the outer surface 12 takes place here between that conically shaped inner surface 9 of the external conductor contact element 5, which has a greater slope than the conically shaped outer surface 12 of the mating external conductor contact element 8, and an outer edge 29 on the outer surface 12 of the mating external conductor contact element 8.

In an equivalent manner, contacting between the conically shaped inner surface 9 of the external conductor contact element and the likewise conically shaped outer surface 12 of the mating external conductor contact element 8 which each have different slopes is apparent from FIG. 6G. Here, the circular line-shaped contacting takes place between the outer edge 29 on the inner surface 9 of the external conductor contact element 5 and the conical inner surface 12 of the mating external conductor contact element 8.

FIG. 6H shows contacting between a conically shaped inner surface 9 of the external conductor contact element 5 and a double-stepped outer surface 12 of the mating external conductor contact element 8. Here, the circular line-shaped contacting takes place between the conical inner surface 9 of the external conductor contact element 5 and the outer edge 29 on the outer surface 12 of the mating external conductor contact element 8.

Contacting between a concavely curved inner surface 9 of the external conductor contact element 5 and a double-stepped outer surface 12 of the mating external conductor contact element 6 results from FIG. 6I. Here, the circular line-shaped contacting takes place between the concavely curved inner surface 9 of the external conductor contact element 5 and the outer edge 29 on the outer surface 12 of the mating external conductor contact element 8.

FIG. 6J shows contacting between a double-stepped inner surface 9 of the external conductor contact element 5 and a convexly curved outer surface 12 of the mating external conductor contact element 8. Here, the circular line-shaped contact results between the outer edge 29 on the inner surface 9 of the external conductor contact element 5 and the convexly curved outer surface 12 of the mating external conductor contact element 8.

Contacting between a concavely curved inner surface 9 of stepped configuration of the external conductor contact element 5 and a convexly curved outer surface 9 of the mating external conductor contact element 8 can be gathered from FIG. 6K. The circular contact results between the outer edge 29 on the inner surface 9 of the external conductor contact element 5 and the convexly curved outer surface 12 of the mating external conductor contact element 8.

FIG. 6L shows contacting between a convexly curved inner surface 9 of the external conductor contact element 5 and a double-stepped outer surface 12 of the mating external conductor contact element 6. The circular contact results in this case between the convexly curved inner surface 9 of the external conductor contact element 5 and the outer edge 29 on the outer surface 12 of the mating external conductor contact element 8.

Finally, contacting between a concavely curved inner surface 9 of stepped configuration of the external conductor contact element 5 and a conically shaped outer surface 9 of the mating external conductor contact element 8 is apparent from FIG. 6M. The circular contact results between the outer edge 29 on the inner surface 9 of the external conductor contact element 5 and the conically shaped outer surface 9 of the mating external conductor contact element 8.

Although the present invention has been described completely above on the basis of preferred exemplary embodiments, it is not restricted thereto, but rather can be modified in a variety of ways.

1. An electrical plug-in connection (1) comprising:
an electrical plug-in connector (2) that defines a longitudinal axis L₁ the electrical plug-in connector (2) having
an external conductor contact element (5) that has a plug-side end region that defines an inner surface (9), and the inner surface, (9) is rotationally symmetrical with respect to the longitudinal axis L₁ of the electrical plug-in connector (2), and the inner surface (9) has an internal diameter which tapers in a direction which is opposed to a plug-in direction S₁ of the electrical plug-in connector (2); and
a corresponding electrical mating plug-in connector (3) that defines a longitudinal axis L₂, the corresponding electrical mating plug-in connector (3) having
a mating external conductor contact element (8) that has plug-side end region that defines an outer surface (12), and the outer surface (12) is rotationally symmetrical with respect to the longitudinal axis 12 of the corresponding electrical mating plug-in connector (3) and the outer surface (12) has an external diameter which tapers in a plug-in direction S₂ of the of the corresponding electrical mating plug-in connector (3); and wherein
the inner surface (9) of the electrical plug-in connector (2), and the outer surface (12) of the corresponding electrical mating plug-in connector (3), contact one another solely on a circular line (15).

2. The electrical plug-in connection (1) as claimed in claim 1 and wherein the internal diameter of the inner surface (9) of the external conductor contact element (5), and the external diameter of the outer surface (12) of the mating external conductor contact element (8) each taper in a manner which is linear, or single-stepped, or multiple-stepped, or curved.

3. The electrical plug-in connection (1) as claimed in claim 2 and further comprising:
a contact plane (30) which is defined by the circular line (15) on the outer surface (12) of the of the mating external conductor contact element (8); and
a longitudinal axis which runs through a center point of the circular line (15) and is oriented orthogonally with respect to the contact plane (30); and wherein
the longitudinal axis is tilted with respect to the longitudinal axis L₂ of the corresponding mating plug-in connector (3), by a tilting angle α_{K} between the longitudinal axis L₁ of the electrical plug-in connector (2) and the longitudinal axis L₂ of the corresponding electrical mating plug-in connector (3); and wherein
the external diameter of the outer surface (12) of the mating external conductor contact element (8) tapers in a linear manner, or tapers in a curved manner.

4. The electrical plug-in connection (1) as claimed in claim 2 and wherein a slope of the inner surface (9) of the external conductor contact element (5), or a slope of the outer surface (12) of the mating external conductor contact element (8) tapers in a linear manner, or tapers in a curved manner, in a range of approximately between 35° and 75°.

5. The electrical plug-in connection (1) U claimed in claim 1 and wherein the circular line (15) is positioned on a peripheral outer edge (29) of the outer surface (12) of the mating external conductor contact element (8), or on a peripheral outer edge (29) of the inner surface (9) of the external conductor contact element (5), or on a convex curvature of the outer surface (12) of the mating external conductor contact element (8), or on a convex curvature of the inner surface (9) of the external conductor contact element (5).

6. The electrical plug-in connection (1) as claimed in claim 1 and wherein the inner surface (9) of the external conductor contact element (5) is axially spaced apart from a plug-side end (10) of the external conductor contact element (5); or
the outer surface (12) of the mating external conductor contact element (8) is axially spaced apart from a plug-side end (13) of the mating external conductor contact element (8).

7. The electrical plug-in connection (1) as claimed in claim 1 and wherein the electrical plug-in connector (2), or corresponding electrical mating plug-in connector (3) has an axially acting clamping means, for making contact with the inner surface (9) of the external conductor contact element (5) and for making contact with the external surface (12) of the mating external conductor contact element (8).

8. The electrical plug-in connection (1) as claimed in claim 1 and further comprising:
an internal conductor contact element (4) of the electrical plug-in connector (2), and the internal conductor contact element (4) is arranged, at least in sections, within the external conductor contact element (5); and,
a mating internal conductor contact element (7) of the corresponding electrical mating plug-in connector (3) is arranged, at least in sections, within the mating external conductor contact element (8); and wherein
the internal conductor contact element (4) contacts the mating internal conductor contact element (7) within an axial portion of the mating external conductor contact element (8).

9. The electrical plug-in connection (1) as claimed in claim 8 and wherein the internal conductor contact element (4) contacts the mating internal conductor contact element (7) within an axial portion of the outer surface (12) of the mating external conductor contact element (8).

10. The electrical plug-in connection (1) J claimed in claim 8 and further comprising:
an inner sheath surface (17) defined in a plug-side end region of the internal conductor contact element (4), and the inner sheath surface (17) defines an internal diameter which tapers in a direction opposite to the plug-in direction S₁ of the electrical plug-in connector (2); and
an outer sheath surface (19) defined in a plug-side end region of the mating internal conductor contact element (7), and the outer sheath surface (19) defines an external diameter which tapers in the plug-in direction S₂ of the corresponding electrical mating plug-in connector (3); and wherein
the inner sheath surface (17) contacts the outer sheath surface (19) solely on a circular line.

11. The electrical plug-in connection as claimed in claim 8 further comprising
an outer sheath surface (19) defined in a plug-side end region of the internal conductor contact element (4), and the outer sheath surface (19) defines an external diameter, and the external diameter tapers in the plug-in direction S₁ of the electrical plug-in connector (2); and
an inner sheath surface (17) defined in a plug-side end region of the mating internal conductor contact element (7), and the inner sheath surface (17) defines an internal diameter, and the internal diameter tapers in a direction opposite to the plug-in direction S₂ of the corresponding electrical mating plug-in connector (3); and wherein
the inner sheath surface (17) contacts the outer sheath surface (19) solely on a circular line.

12. The electrical plug-in connection (1) as claimed in claim 8 and wherein in order to make contact between the internal conductor contact element (4) and the mating internal conductor contact element (7), at least one of, the internal conductor contact element (4) and the mating internal conductor contact element (7) is mounted in a sprung manner.

13. The electrical plug-in connection (1) as claimed in claim 8 and further comprising:
an axial leadthrough having a round cross-sectional profile is defined in the electrical plug-in connector (2) and defined in the corresponding electrical mating plug-in connector (3); and
the axial leadthroughs are for receiving the internal conductor contact element (4) and for receiving the mating internal conductor contact element (7), respectively.

14. The electrical plug-in connection (1) as claimed in claim 2 and wherein the internal diameter of the inner surface (9) and the external diameter of the outer surface (12) taper with a different slope.

15. The electrical plug-in connection (1) su claimed in claim 1 and wherein the inner surface (9) of the plug-side end region of the external conductor contact element (5) and the outer surface (12) of the plug-side end region of the mating external conductor contact element (8) make contact with one another on the circular line (15) in every possible plug-in state of the plug-in connection (1).

16. The electrical plug-in connection (1) as claimed in claim 2 and wherein a slope of the inner surface (9) of the external conductor contact element (5), or a slope of the outer surface (12) of the mating external conductor contact element (8) is 60°.

17. The electrical plug-in connection (1) as claimed in claim 7 and wherein the axially acting clamping means is an axially acting clamping spring (14).

18. The electrical plug-in connection (1) as claimed in claim 12 and wherein the sprung manner, is a compression spring (22) between two axially spaced-apart part bodies (21₁, 21₂) of the internal conductor contact element (4), and the mating internal conductor contact element (7).

19. The electrical plug-in connection (1) as claimed in claim 2 and wherein the internal diameter of the inner surface (9), and the external diameter of the outer surface (12), taper with a different curvature radii.

20. The electrical plug-in connection (1) as claimed in claim 1 and wherein the inner surface (9) of the plug-side end region of the external conductor contact element (5), and the outer surface (12) of the plug-side end region of the mating external conductor contact element (8) make contact with one another on the circular line (15) even in a case of co-axial orientation of the longitudinal axes (L₁, L₂) of the plug-in connector (2) and the mating plug-in connector (3).
